(19) United States
(12) Patent Application Publication
(10) Pub. No.: US 2008/0185065 A1
(43) Pub. Date: Aug. 7, 2008

(54) Multilayer Pipe

(75) Inventors: Stefan Dreckotter, Osnabruck (DE); Jyri Jarvenkyla, Hollola (FI); Christian Ragoss, Wiehl (DE); Franz-Josef Riesselmann, Lohne (DE)

Correspondence Address: SHUMAKER & SIEFFERT, P. A., 1625 RADIO DRIVE, SUITE 300, WOODBURY, MN, 55125, US

(73) Assignee: Uponor Innovation AB, Fristad (SE)

(21) Appl. No.: 11/916,911

(22) PCT Filed: Jun. 9, 2006
(86) PCT No.: PCT/EP06/63064

§ 371 Date: Feb. 22, 2008

(30) Foreign Application Priority Data
Jun. 9, 2005 (EP) 05105092.0

(51) Int. Cl. F16L 9/133; F16L 9/12; F16L 57/06; B32B 1/08

(52) U.S. Cl. 138/141; 428/36.91; 138/143

(57) ABSTRACT

The pipe for use in the field of sanitation and/or heating, comprises —an inner layer made of a fluoπnated polymer material, —an adhesive layer being in contact with the inner layer, and —an outer layer being in contact with the adhesive layer and including a polyolefin material, —wherein the adhesive layer is configured to bond the fluorinated polymer material of the inner layer to the polyolefin material of the outer layer.

The invention is directed to an improved multilayer pipe and, in particular, a pipe for use in the field of sanitation and/or heating, comprising a barrier layer on the inner side of the pipe, which is in contact with the medium.

In the last twenty years, plastics pipes have considerably gained importance as tap water pipes and have often replaced pure metal pipes. The advantages of plastics pipes are, among others, that no corrosion and no deposits form thereon. However, plastics pipes have limited working temperatures. This is due to the fact that, as the temperature rises, the washing out and/or consumption of the additives of the plastics material such as antioxidants and their respective reaction and breakdown products increases exponentially, thus prematurely undoing the “long-term protection”. However, high working temperatures and the use of disinfectants are advantageous in that all germs, such as legionellae or the like can be killed to guarantee hygienically clean water for sanitary applications. Also the additives might migrate into the fluid (e.g. water) within the pipe.

Multilayer plastic pipes are also common for example in fuel piping. Typical barriers are polyamides and fluorinated plastics. Typically, the barrier layer is located in the middle of the pipe and the reason for their usage is preventing full permeation through the pipe; e.g. environmental protection or enhancing the chemical resistance of the pipe structure.

The user of a barrier layer (e.g. made of EVOH or metal) in hot water applications is similarly common practice. Here the barriers are used for same purpose but for preventing for example oxygen permeation into the pipe which could cause corrosion in radiators or other metal parts in contact with the water flowing through the pipe.

This invention relates to the use of barrier layer in hot (and cold) water applications like tap water pipes (where barriers are not normally used because oxygen is not a problem), in heating pipes like radiator pipes and district heating pipes.

The invention relates to the constitution of the barrier and the placing of the barrier as the innermost layer of the multilayered structure.

The long-term performance of plastics pipes is typically evaluated using the SEM method where the pipe is pressurized at elevated temperatures and the time to rupture is measured at different stress levels. Considerable research effort has been focused on so-called stage III failure mode, which take place when the stabilizer package has ceased to be effective.

The general problem of this test method relates to the use of stagnant water inside and water bath outside. Hence it is unable to reveal real performance differences when the water inside the pipe is oxygen enriched (e.g. drinking water) and when the outer media is air. A typical environment for recirculating tap water piping inside buildings.

Moreover, stabilizers are added to thermoplastic polymers for increasing lifetime. Stabilisation of thermoplastic polymers is usually accomplished by melt blending with one or more stabilizers. In this way a heterophase polymer/stabilizer system is formed, which may be best described as a physical dispersion of a low molecular weight stabilizer in a polymer matrix. The vast majority of commercial stabilizer compounds have very different chemical structure from that of the non-polar host thermoplastic polymer. For this reason, the compatibility of various conventional stabilizers with polyolefins is poor, leading to migration of the added stabilizers across the boundary of the polyolefin with neighbouring fluids, liquids, gases or solid materials. This loss of stabilizer substantially shortens the lifetime of the polyolefin.

Plastic materials are known from prior art that have an improved temperature resistance and are hygienically unobjectionable. For example, these are fluorinated polymer materials such as PVDF (polyvinyldifluoride), PTFE (polytetrafluorethylene) and their modifications. However, these materials are hardly used in ordinary tap water pipes due to their high cost.

Further, WO-A-02/081188 discloses a three-layer pipe structure with an inner layer of fluorinated polymer material, an intermediate layer of metal, and an outer layer of conventional thermoplastic material such as PE (polyethylene) (cross-linked or not).

EP-A-0 878 509 discloses an adhesive for a multilayer pipe comprising two or three layers of PVDF, PA and/or thermoplastic polyester. The adhesive consists of polymers of the respective two materials to be connected and a compliant material.

EP-A-0 673 762 describes a multilayer pipe having two layers of PA and a mixture of PVDF and acrylatcopolymer.

EP-A-0 729 830 discloses a thermoplastic multilayer compound comprising layers of PVDF, a mixture of PA, adhesive, and PO. Since pure PA does not have any adhesion to PVDF, polyglutarimid is mixed to the PA. The adhesive layer is a normal adhesive, while the PO layer comprises common polyolefin like PE or PP.

Finally, EP-A-0 739 712 discloses a hose construction containing fluoroplastic terpolymers. The multilayer compound is co-extruded and comprises rubber, a barrier (tetrafluorethylene), and again rubber. The rubber of the two layers is mixed with suitable additives or other compositions for providing adhesion to the barrier layer.

Due to the relatively high prime costs of the above mentioned materials, developments have been made to be able to use the individual materials such that the requirements made can be met with, while substantially reducing the manufacturing costs.

It is an object of the invention to provide a reasonably low-cost multilayer pipe for tap water, radiator and district heating pipes having a barrier layer which preferably is in contact with the medium.

The object is achieved by the invention with a pipe for use in the field of sanitation and/or heating, the pipe being provided with
an inner layer made of a barrier plastics material like halogenated polymers, in particular, polyolefins, wherein the halogenated polymers or polyolefins are fluorinated and/or chlorinated,
an adhesive layer being in contact with the inner layer, and
an outer layer being in contact with the adhesive layer and including a polyolefin material,
wherein the adhesive layer is configured to bond the barrier material of the inner layer to the polyolefin material of the outer layer.

Accordingly, the subject matter of the invention relates to a pipe comprising at least three layers of plastics material namely an inner or barrier layer, an adhesive layer and an outer layer being in contact with the adhesive layer. The materials of these three layers are specified as mentioned above.

The plastics layers of the pipe according to the invention can establish the pipe as such but can also be combined with additional layers of a multilayer pipe. In particular, it is possible that the inner or barrier layer is in direct contact with the medium or fluid within the pipe. In this case it would be advantageous if the material for the barrier layer had a good resistance against hydrolysis.

The pipe according to the invention can be used as the inner pipe construction of a multilayer composite pipe including at least one metal layer (e.g. of copper, aluminum, titanium, and in a thickness of between 50 to 10000 μm). For arranging the metal layer around the above-mentioned plastics layer of the pipe, several different techniques are known in the art which all can be used for the pipe according to the invention. In particular, the metal layer may be built from a metal strip wrapped or folded around the pipe and welded together at its opposite end in an overlapping or abutting manner. Also it is possible to attach the opposing overlapping lateral edges of the metal strip by means of an adhesive. The metal layer could be formed first with the above-mentioned plastics layer of the pipe according to the invention being extruded against the inner surface of the metal layer. According to an alternative, the plastics layers of the inner pipe according to the invention are made and extruded first with the metal layer arranged around the thus extruded pipe thereafter.

A common method for studying stabilizer migration or leaching out involves immersing the pipe in boiling water with subsequent measurement of the oxidation induction time (OIT) level, which gives an indication of how much active stabilizer is remaining in the pipe and measures how easily the stabilizer is able to leach out of the pipe wall. By measuring the OIT levels at different time intervals it is possible to estimate the lifetime of the pipe by extrapolation.

This methodology is not very useful for analyzing pipes according to the invention because the stabilizer of the load carrying layer (object of the measurement) can also diffuse towards outer layers and into the ambient air or other environment. Hence in order to get relevant to practical results, the pipe samples are flushed with hot oxygen rich water and the pipes outer layer is towards ambient air. In test arrangement like this the efficiency of placing the barrier as innermost layer can be reliably studied.

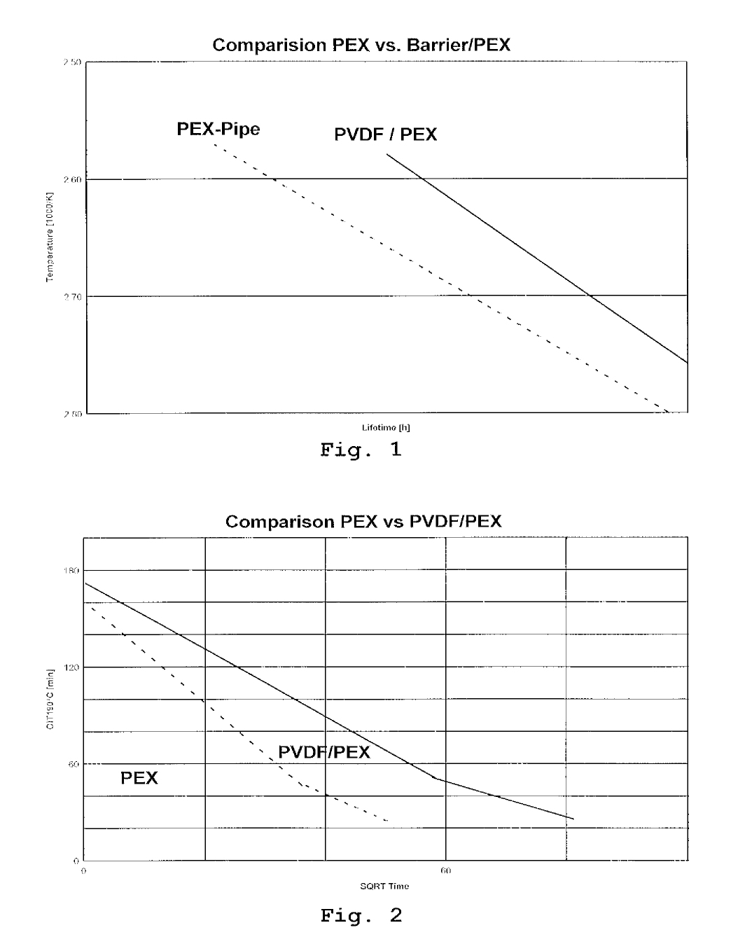

Surprisingly, it was found that by placing in a polyolefin pipe an additional barrier layer as innermost layer the lifetime of the multilayer pipe at elevated temperature is greatly improved when measured both using the standard SEM method as well as a test using oxygen enriched water and ambient air outside the pipe. In the tests made with the pipe structure according to the invention it was noticed that the long term performance. It was found out by applying the above-mentioned analysis techniques that there is an indication of improvement of lifetime expectancy in a range of at least 20% as much as measured from the same load carrying pipe, i.e. the load carrying pipe with and without the barrier layer (see FIG. 1).

Without being bound to any specific theory, it been assumed that the lesser solubility of stabilizers and their reaction residual to the innermost barrier layer slow down their migration out of the load carrying matrix material with improved performance as result.

Without binding it to any specific phenomenon it is assumed that the useful function of the barrier is different from previous uses of barriers in polyolefin pipes. According to the invention the barrier prevents the stabilizer from leaching into the transported water. It may also slow down active oxygen from the water to diffuse into the load carrying polyolefin layer (outer layer) and hence limiting the amount of active radicals in the matrix. Hence a good barrier for this purpose does not to be an effective oxygen barrier; essential is that the barrier is effective in preventing bigger molecules than oxygen from leaching out. Indeed the preferred barrier material, namely PVDF, is not very effective as oxygen barrier when applied as such thin layers as suggested according to several embodiments of the invention. But, as such, PVDF is still a barrier good enough for bigger molecules.

Typical molecular weights of common stabilizers (and their breakdown products) vary in the region of 100 to 3000. The minimum requirement for the inner barrier is hence that it has at least 10, preferably 100 times, lesser migration than conventional PE grades for these molecules.

The positive overall performance of the multilayer pipe is also improved in another way; the innermost barrier prevents stabilizers and their reaction residuals from leaching into the drinking water thus improving the water quality.

In one embodiment of the invention the barrier is adhered to the polyolefin layer with an adhesive which is in essence of the same resin as the barrier itself but which has grafted or polymerized active functional endgroups. Typically the adhesive would be a mixture of the barrier resin and a masterbatch consisting of such grafted resin.

The thickness of the individual layers of the pipe according to the invention can be chosen in accordance with prior art multilayer pipes. In particular, the thickness of the inner or barrier layer of a 20 mm pipe can be from 5 to 1000 μm, more specifically 5 to 400 μm, and most specifically 30 to 100 μm. The adhesive layer may have a thickness of about 5 to 500 μm and more specifically 20 to 100 μm. The outer layer of polyolefin material may have a thickness from 2 to 30% of the outer diameter of the complete pipe structure the diameter of which may range from 2 to 2000 mm. Accordingly, for a 1000 mm pipe the barrier layer could vary from 0.1 mm to 3 mm.

According to the invention, in one embodiment the inner or barrier layer comprises PVDF and an adhesive layer which bonds the PFDF layer to the outer polyolefin layer. As an alternative, the adhesive layer may comprise two sublayers one of which comprises a PVDF copolymer for bonding to the PVDF layer while the other adhesive sublayer bonds the PVDF copolymer adhesive sublayer to the polyolefin layer. In any case the adhesive layer or layers may comprise diverse polymers with polar groups for obtaining adhesion to the different materials. The pipe can be cross-linked or is not cross-linked in accordance with methods known in the art (radiation cross-linking or peroxide cross-linking or silan cross-linking).

Generally, one aspect of the present invention relates to the fact that for the adhesive layer contacting the barrier layer a material is used which is based on the same polymer than that for the inner layer plus modifications (grafted polymer) in order to provide adhesion to the barrier layer.

According to another aspect the present invention is characterized by improving the oxidation stability of a polyolefin based hot or cold water pipe in that a halogenated (for example fluorinated and/or chlorinated) polymer and, in particular a halogenated polyolefin is used as an inner harrier layer preventing diffusion of oxygen and leaching out stabilizers and/or other additives of the polyolefin pipe.

The complete pipe structure, barriers adhesive(s), and outer polyolefin layers might be cross-linked for example with radiation. This yields to a pipe wherein all layers are cross-linked. This improved the long term performance at elevated temperatures and it also improves the adhesion between the layers.

Alternatively, the pipe structure according to the invention comprises e.g. PVDF as inner layer, grafted PVDF which, accordingly, contains an adhesive and has adhesive properties with respect to the inner layer, and a outer layer of PE which is cross-linked by a peroxide. This pipe construction can be subjected to IR heating which results in the PE layer to be cross-linked with additional adhesion and bonds to the adhesive layer leading to an improved adhesion. The pipe construction retains the original elasticity of the inner or barrier layer.

The purpose of the present invention is to protect a polyolefin layer used for a pipe with comparatively thin plastics barrier materials
to avoid the corrosion of any metal layer,
to reduce migration of substances from pipe layer materials into the water resulting in more natural water being transported in the pipe and an increase of the amount of residual antioxidants in the pipe materials,
to reduce the oxygen permeation from the water into the pipe materials and hence reduce free radical creation and antioxidant need,
to increase the application temperature,
to decrease interactions between disinfectants and pipe materials, and
the introduction of such barrier layers instead of using solid wall barrier material pipes additionally may reduce cost of eventually expensive barrier materials then being compared to common polyolefin types.

In one embodiment of the present invention, the adhesive layer comprises at least two adjacent adhesive sublayers with the first sublayer in contact with the inner layer and configured to bond to the barrier plastics material of the inner layer and with the second sublayer in contact with the outer layer and configured to bond to the polyolefin material of the outer layer. The adhesives adhere also to each other.

In another embodiment of the present invention, the first adhesive sublayer includes a material comprising components of the material of the inner layer and components of the polyolefin material of the outer layer and wherein the second adhesive sublayer includes a material based on the polyolefin material of the outer layer with polar groups.

More specifically, the first adhesive sublayer may include a material comprising components of the material of the inner layer and maleic anhydride (MA) and the second adhesive sublayer may include a material based on the polyolefin material of the outer layer and GMA (glycidyl methacrylate).

In still a further embodiment of the present invention, the adhesive layer comprises a third adhesive sublayer arranged between the first and second adhesive sublayers and configured to bond to the materials of the first and second adhesive sublayers. By way of this third sublayer the pipe can be provided with an additional functionality like e.g. a further barrier for preventing oxygen from diffusing from the inside of the pipe to its outside.

In particular, the first adhesive sublayer includes a material comprising components of the material of the inner layer, the second adhesive sublayer includes a material based on the polyolefin material of the outer layer and MA, and wherein the third adhesive sublayers comprises EVOH which may act as an additional oxygen barrier layer.

According to a further aspect of the present invention, the barrier plastics material comprises homopolymers, copolymers or their respective blends of fluorinated polymers or, more specifically, polyolefins, like e.g. PTFE, FEP, E/TFE, THV, PCTFE, PVDF, PVF, PFA, MFA, E-CTFE. As an alternative the barrier plastics material comprises homopolymers, copolymers or their respective blends of chlorinated polymers or, more specifically, polyolefins, like e.g. CPVC, PVDC or other halogen substituted polyvinyl homo- or copolymer. Suitable barriers are also polyketone and other polymers having lower permeability at elevated temperatures of medium sized molecules than the matrix polyolefin.

Although the barrier properties (relative to the matrix polyolefin) can be beneficial when regarding the long term pressure performance, the key feature in this invention is that the barrier prevents or slows down markedly the diffusion of the stabilizers and their intermediate reaction or breakdown products (which also often act as stabilizers although the molecular chain length has been shortened) from the matrix material to the water inside.

The above described and generally explained pipe with the layer structure of inner layer-adhesive layer-outer layer can be provided on its outside with another adhesive layer around which, for example, a metal band is formed or wrapped and welded longitudinally or placed around the pipe in another way.

The metal band which may be made of aluminum or an aluminum alloy is itself provided with a adhesive layer to bond the metal band with an outer sheath of thermoplastic material which mechanically protects the metal band. Thus, a multilayer composite pipe is provided having as its medium-conveying inner or basic pipe a structure with the multilayer structure according to the invention.

Such a multilayer composite pipe has two barrier layers between which the load carrying polyolefin layer (referred to as outer layer hereinabove) is arranged (plus adhesive layers). The metal layer protects the polyolefin layer from oxygen and the innermost barrier layer prevents the stabilizers of the polyolefin layer from leaching out. Accordingly, the load carrying layer of the pipe is protected from both sides.

More specifically, a second adhesive layer is arranged around and in contact with the outer layer and wherein a metal layer is arranged around and in contact with the second adhesive layer. The second adhesive layer may comprise at least two adhesive sublayers the one bonding to the outer layer and the other bonding to the metal layer.

In another preferred embodiment of the invention, a third adhesive layer is arranged around and in contact with the metal layer and wherein a polyolefin layer is arranged around and in contact with the third adhesive layer. The third adhesive layer may comprise at least two adhesive sublayers the one bonding to the metal layer and the other bonding to the polyolefin layer.

In another aspect of the present invention, the polyolefin material comprises cross linked or non-cross linked homopolymers, copolymers or their respective bends like e.g. PP, PE, PB, or EVA.

The pipe according to the invention as described above can be formed in that the inner and outer layers and the single or multiple adhesive layer are made by extrusion.

The layer structure detailed above pertains to the medium-conveying part of a multilayer pipe. According to the invention, it is not excluded that further layers or materials are added to the outer layer and arranged outside the outer layer but can also be added to the inner or barrier layer.

In an advantageous development of the invention, the adhesive layer comprises a first and a second adhesive layer. The first adhesive layer is in contact with the inner layer, whereas the second adhesive layer establishes the contact between the first adhesive layer and the outer layer. The second adhesive layer is a standard adhesive as presently used in the manufacture of pipes. This adhesive is a material based on thermoplastics with polar groups for bonding unipolar components to polar components. The first adhesive includes a material comprising components of the inner layer material and of the thermoplastic material of the second adhesive layer.

According to the invention, the single or multilayer adhesive layer is provided with a material including components of the inner layer material and of a thermoplastic material (of the outer layer, for example) and/or polar groups.

The pipe can also be made by extruding the inner layer and by forming at least one of the other layers and, in particular, the adhesive layer (one or several sublayers) by a varnishing process.

In another embodiment of the present invention, the multilayer pipe for conveying hot or cold water comprises at least one principal hydrostatic load carrying plastic layer based on polyolefin resin and at least one barrier layer made of another thermoplastic resin, wherein the thickness of the barrier layer, which is located innermost, is more than 0.01% and less than 10% of the total wall of the pipe.

In still another embodiment of the present invention, the multilayer pipe according to the invention comprises one or more barrier layers and load carrying plastics layers wherein the long term performance (life expectancy) at elevated temperature determined with SEM method is improved by placing a polymeric barrier as the innermost layer of the pipe structure and said layer is adhered to subsequent outer load carrying plastic layer(s), where the innermost barrier consists of halogenated thermoplastic and where the adhesive layer in between the innermost barrier layer and the subsequent load carrying thermoplastic consists of the same base resin as the barrier layer and active end groups like maleic anhydride, epoxy etc. depending on the chemical nature of the load carrying layer.

An embodiment of the present pipe having the above mentioned layers may be structured as follows:
Inner layer: thin layer of fluorinated polymer layer thickness of 0.05 mm to 1.0 mm (depending on the pipe dimensions)
1. adhesive layer: to achieve bonding between the fluorinated polymer and the thermoplastic material, a special adhesive is necessary which makes the bond between the inner layer and the second adhesive which generally is a standard adhesive. The adhesive layer 1 is composed such that it includes components of the inner layer material and of thermoplastics present in the outer layer.
2. adhesive layer: the second adhesive layer is to achieve the bonding with the thermoplastic material of the outer layer which, for example, is PE (cross-linked or not, or PEX, i.e. irradiation cross-linked). This layer fulfills the mechanical functions as conventional.
Outer layer: cross-linked polyethylene (PEX-a, PEX-b or PEX-c) or other cross-linked or not cross-linked thermoplastics such as PE-RT, PP, PB, PVC, etc.

The inner pipe is cross-linked in a conventional manner such as with α or β radiation. Tests have shown that this multilayer pipe can be completely cross-linked by irradiation.

According to another embodiment the multilayer pipe comprises a PVDF inner layer (barrier layer), a PVDF adhesive layer with epoxy function and a PE-RT or any other PEX outer layer as the load carrying layer. This pipe construction is an example for a flexible and bendable pipe.

Another example for a flexible and bendable pipe for tap water and heating purposes with an enhanced oxygen barrier performance comprises an inner layer of PVDF, an adhesive layer of PVDF modified by a maleic anhydride or having a maleic anhydride function, an EVOH layer, a further adhesive layer which is a standard PE based adhesive, and a PE-RT or any other PEX outer layer as the load carrying layer.

In still another embodiment of the present invention a multilayer composite pipe has the following construction (mentioning of the layers in the order from inside to outside of the pipe):
barrier layer (inner layer)
barrier resin based adhesive (first adhesive sublayer)
polyolefin based adhesive with end groups adhered against the barrier based adhesive and polyolefin (second adhesive sublayer)
polyolefin load carrying layer (outer layer)
polyolefin based adhesive with end groups adhered against aluminum
aluminum (metal layer)
polyolefin based adhesive with end groups adhered against aluminum
polyolefin layer (outer protective layer)

A pipe with a 4-layer design and dimension 17 mm outer diameter and 2 mm wall thickness was co-extruded. The construction with average layer thicknesses (inside to outside) was: 300 μm polyvinylidenefluoride homopolymer, 100 μm polyvinylidenefluoride homopolymer based tie layer material with radiation grafted maleic anhydride, 140 μm ethylene-glycidyl methacrylate copolymer and 1500 μm polyethylene pipe grade. With known stabilization package based on phenolic AO's. The coextruded product was exposed to electron beam irradiation resulting in a crosslinking degree of approx 65%. A solid wall pipe with dimensions 17×1.6 mm of pure polyethylene pipe grade was extruded and crosslinked in the same way and used as a reference.

Both pipes were exposed to deionised, circulating oxygen enriched water at 115° C. and outside ambient temperature. The water replacement rate of the system volume was approximately 10% per hour.

Results of investigation are shown in FIG. 2.

Pipes according to the invention were subjected to various tests that led to surprising results:
1. the organoleptic properties could be enhanced.
2. the migration behavior of the additives into the water could be substantially reduced as compared to current “standard plastic pipes”.
3. the application technique tests have shown that the pipe is fit for use with elevated temperatures.
4. the halogenated material is also a reasonable oxygen diffusion barrier, thereby substantially reducing the oxidative damage to the pipe. In the first place the barrier plastics material serves for preventing migration of additives (e.g. stabilizers) of the polyolefin material out of the outer layer.

The multilayer pipe according to the invention can be used advantageously for conveying chlorinated hot water. Namely, oxidative degradation caused by chlorine can be compensated in the multilayer pipe according to the invention due to the improvement against such oxidative degradation due to the barrier layer. Also the multilayer pipe according to the invention can be used in recirculating tap water systems for hot water. Finally, according to the invention and due to the barrier layer a multilayer pipe for conveying tap water as well as hot or cold water (e.g. for heating and cooling purposes) comprising one or more barrier layers and a load carrying plastics layer is improved in that the long-term performance (life expectancy) at elevated temperatures determined with SEM method is improved by placing a chlorinated polymeric barrier layer as the innermost layer of the pipe structure with the barrier layer adhered to the subsequent outer load carrying plastics layer.

Also by way of the present invention it is possible to build flexible tap water pipes or, in general, bendable multilayer pipes for tap water or hot and cold water applications and, in particular, for recirculating systems.

1. A pipe for use in the field of sanitation and/or heating, comprising
an inner layer made of a halogenated polymer material,
an adhesive layer being in contact with the inner layer, and
an outer layer being in contact with the adhesive layer and including a polyolefin material,
wherein the adhesive layer is configured to bond the halogenated polymer material of the inner layer to the polyolefin material of the outer layer.

2. The pipe according to claim 1, wherein the adhesive layer comprises at least two adjacent adhesive sublayers with the first sublayer in contact with the inner layer and configured to bond to the halogenated polymer material of the inner layer and with the second sublayer in contact with the outer layer and configured to bond to the polyolefin material of the outer layer

3. The pipe according to claim 2, wherein the first adhesive sublayer includes a material comprising components of the material of the inner layer and components of the polyolefin material of the outer layer and wherein the second adhesive sublayer includes a material based on the polyolefin material of the outer layer with polar groups.

4. The pipe according to claim 2 or 3, wherein the first adhesive sublayer includes a material comprising components of the material of the inner layer and MA and wherein the second adhesive sublayer includes a material based on the polyolefin material of the outer layer and GMA.

5. The pipe according to claim 2, wherein the adhesive layer comprises a third adhesive sublayer arranged between the first and second adhesive sublayers and configured to bond to the materials of the first and second adhesive sublayers.

6. The pipe according to claim 5, wherein the first adhesive sublayer includes a material comprising components of the material of the inner layer, the second adhesive sublayer includes a material based on the polyolefin material of the outer layer and MAH, and wherein the third adhesive sublayers comprises EVOH.

7. The pipe according to any one of claims 1 to 6, wherein the barrier plastics material comprises halogenated, e.g. fluorinated or chlorinated polymers and, in particular, halogenated polyolefins.

8. The pipe according to any one of claims 1 to 6, wherein the barrier material comprises homopolymers, copolymers or their respective blends like e.g. PTFE, FEP, E/TFE, THV, PCTFE, PVDF, PFA, MFA, polyketones.

9. The pipe according to any one of claims 1 to 6, wherein the barrier material comprises homopolymers, copolymers or their respective blends like e.g. CPVC, PVDC.

10. The pipe according to any one of claims 1 to 9, wherein a second adhesive layer is arranged around and in contact with the outer layer and wherein a metal layer is arranged around and in contact with the second adhesive layer.

11. The pipe according to claim 10, wherein the second adhesive layer comprises at least two adhesive sublayers the one bonding to the outer layer and the other bonding to the metal layer.

12. The pipe according to claim 10 or 11, wherein a third adhesive layer is arranged around and in contact with the metal layer and wherein a polyolefin layer is arranged around and in contact with the third adhesive layer.

13. The pipe according to claim 12, wherein the third adhesive layer comprises at least two adhesive sublayers the one bonding to the metal layer and the other bonding to the polyolefin layer.

14. The pipe according to any one of claims 1 to 13, wherein the polyolefin material comprises cross linked or non-cross linked homopolymers, copolymers or their respective bends like erg. PP, PE, PB, or EVA.

15. The pipe according to any one of claims 1 to 14, wherein the inner and outer layers and the single or multi adhesive layer are made by extrusion.

16. The pipe according to any one of claims 1 to 15, wherein the adhesive layer is based on the same halogenated polymer than the inner layer and further includes modifications for providing adhesion to the inner layer.

17. Use of halogenated polymers and, in particular, fluorinated or chlorinated polymers like polyolefins, as an inner layer of a polyolefin based tap water or hot or cold water pipe for improving the oxidation stability and leaching out resistance of stabilizers and/or other additives of the polyolefin based pipe.
